(19) United States
(12) Patent Application Publication
(10) Pub. No.: US 2025/0184281 A1
(43) Pub. Date: Jun. 5, 2025

(54) Variable Data Transmission To Lower Power Consumption

(71) Applicant: Cisco Technology, Inc., San Jose, CA (US)

(72) Inventors: Spandana Mahendra, San Jose, CA (US); ANIRUDH BALAJI AKKALDEVI, Milpitas, CA (US); Corbin E. Jarrett, San Francisco, CA (US); Venkata Sai Sameer Raghav Medicherla, San Jose, CA (US)

(21) Appl. No.: 18/524,309

(22) Filed: Nov. 30, 2023

(51) Int. Cl. H04L 47/6275; H04L 47/80

(52) U.S. Cl. CPC H04L 47/6275; H04L 47/805

(57) ABSTRACT

Described herein are devices, systems, methods, and processes for improving the energy efficiency of network devices by managing the activation of the transmit (TX) components according to data traffic demand. The embodiments enable network devices to operate in a low-power state and activate the TX component only when necessary, such as when incoming data reaches a predefined threshold volume. This approach leverages batching techniques where data is accumulated before being transmitted, reducing the constant energy draw characteristic of traditional network device operations. Additionally, priority levels may determine the activation of the TX component, with higher priority data having lower thresholds. Furthermore, network devices can coordinate data transmission based on network traffic. These embodiments facilitate a demand-responsive network environment with potential for substantial energy savings, particularly relevant in the context of global energy conservation initiatives.

The present disclosure relates to networking technology. More particularly, the present disclosure relates to energy-efficient data transmission in network equipment.

### BACKGROUND

Networking equipment has traditionally been designed on the premise of constant readiness to handle data traffic. Historically, devices have been implemented to remain active, consuming power regardless of the actual demand for data processing or transmission. This continuous operation includes the maintaining of synchronous logic, where data is clocked in every cycle, and the establishment of uninterrupted communication channels, even when conveying idle signals instead of actual payload data.

With the advent of energy-aware initiatives and increasing environmental concerns, the energy consumption of network devices has come into sharper focus. Across other sectors, such as server technology and mobile telecommunications, there has been a significant push to reduce the energy footprint of electronic devices. These industries have optimized power usage by implementing strategies that scale energy consumption with demand, reflecting a shift in design philosophy that is becoming more prevailing.

In the context of networking equipment, the continuous power draw has been considered an inherent part of the functionality of the network device. The ongoing power consumption, often referred to as “idle power,” persists even when the network traffic is low or non-existent. As energy conservation becomes not only a goal but an expectation for modern technology, the practice of continuous power usage without consideration of network load has proven to be a disadvantage in terms of energy efficiency. It presents a challenge to align network equipment with emerging standards of energy utilization and sustainability.

### SUMMARY OF THE DISCLOSURE

Systems and methods for protecting software agents from various services while operating within a workload protection solution in accordance with embodiments of the disclosure are described herein. In some embodiments, a network device includes a processor, at least one network interface controller configured to provide access to a network, and a memory communicatively coupled to the processor, wherein the memory includes a communication logic. The logic is configured to receive one or more packets, store, temporarily, the received one or more packets, identify whether a condition is met, and refrain from forwarding the stored one or more packets in response to the condition not being met, wherein a transmit (TX) portion of the network device is off when no packet is being forwarded from the network device.

In some embodiments, the one or more packets are received from one or more other network devices.

In some embodiments, the communication logic is further configured to forward at least some of the stored one or more packets to at least a first network device in response to the condition being met, wherein the TX portion of the network device is on when the at least some of the stored one or more packets are being forwarded.

In some embodiments, the communication logic is further configured to turn off the TX portion of the network device in response to the forwarding of the at least some of the stored one or more packets being completed.

In some embodiments, the TX portion of the network device includes one or more of a TX processor, a TX serializer/deserializer (SerDes), or a TX buffer.

In some embodiments, the condition is met when the stored one or more packets include at least a threshold number of packets.

In some embodiments, the one or more packets are each associated with a priority level.

In some embodiments, the priority level is selected from a group consisting of a predetermined number of possible priority levels.

In some embodiments, the priority level corresponds to a quality of service (QOS) specification.

In some embodiments, the threshold number is based at least in part on the priority level.

In some embodiments, the threshold number and the priority level are inversely correlated.

In some embodiments, the threshold number is based at least in part on at least one of a time of day, a day of week, a month of year, a date range, or a season.

In some embodiments, the condition is met when a timer expires, and wherein the timer is reset when forwarding of at least some of the stored one or more packets is completed. In some embodiments, the one or more packets are each associated with a priority level.

In some embodiments, a duration of the timer is based at least in part on the priority level.

In some embodiments, the duration of the timer and the priority level are inversely correlated.

In some embodiments, a duration of the timer is based at least in part on at least one of a time of day, a day of week, a month of year, a date range, or a season.

In some embodiments, the network device includes a switch or a router.

In some embodiments, a network device includes a processor, at least one network interface controller configured to provide access to a network, and a memory communicatively coupled to the processor, wherein the memory includes a communication logic. The logic is configured to place the network device in a first state, wherein a transmit (TX) portion of the network device is off when the network device is in the first state, receive and store, temporarily, one or more packets from at least a first network device while the network device is in the first state, the first network device being in a second state, place the network device in the second state, wherein the TX portion of the network device is on when the network device is in the second state, and forward at least some of the stored one or more packets while the network device is in the second state, wherein the network device switches between the first state and the second state.

In some embodiments, a method for forwarding packages implemented at a network device includes receiving one or more packets, storing, temporarily, the received one or more packets, identifying whether a condition is met, and refraining from forwarding the stored one or more packets in response to the condition not being met, wherein a transmit (TX) portion of the network device is off when no packet is being forwarded from the network device.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a schematic diagram of a network with network devices powered by various power source types in accordance with an embodiment of the disclosure;

FIG. 2 is a diagram illustrating the energy consumption states of various components within a transceiver circuitry of a network device in accordance with various embodiments of the disclosure;

FIG. 3 is a diagram illustrating the transceiver circuitry of a network device configured to accommodate data associated with different priority classifications in accordance with various embodiments of the disclosure;

FIG. 4 is a diagram illustrating the super pooling process among network devices in accordance with various embodiments of the disclosure;

FIG. 5 is a flowchart showing a process for managing data packet storage and transmission in a network device in accordance with various embodiments of the disclosure;

FIG. 6 is a flowchart showing a process for managing data packet storage and transmission in a network device in accordance with various embodiments of the disclosure;

FIG. 7 is a flowchart showing a process for super pooling in a pseudo-asynchronous network in accordance with various embodiments of the disclosure; and

FIG. 8 is a conceptual block diagram for one or more devices capable of executing components and logic for implementing the functionality and embodiments described above.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein that may enhance energy efficiency in network devices by intelligently controlling the activation of components based on data traffic volume and/or priority. The embodiments can enable a network device to remain in a low-power state until the accumulation of traffic necessitates data transmission, thus reducing unnecessary power consumption.

In many embodiments, the network device can be a switch or another type of networking equipment. In a number of embodiments, the receive (RX) component of a network device may remain continually operational, ensuring constant network monitoring. Conversely, the transmit (TX) component can be turned off by default, and may be activated just in response to certain conditions, such as when a threshold volume of data is collected. In a variety of embodiments, the threshold volume of data may correspond to a predetermined threshold number of packets. In some embodiments, the RX buffer can be continually operational but the TX buffer may be off by default and activated on demand.

In more embodiments, a network device may incorporate data bursting through batching. In particular, a network device can accumulate incoming data until a specified threshold is met, such as when a predetermined threshold number of packets have been accumulated. In additional embodiments, the transmission of accumulated data may also be based on a (timeout) timer. In further embodiments, the timer can trigger the transmission of the accumulated data, regardless of whether the threshold number of packets have been reached, to ensure timely processing of the data flow. The timer may be reset when the transmission of the accumulated data is completed. Accordingly, by way of a non-limiting example, in situations where a video is loading, the buffering may occur within the network device rather than on the application side.

In still more embodiments, multiple priority classes or levels can be defined for the data packets that transit through the network device. In still further embodiments, each priority class may be associated with a respective threshold volume (and potentially a respective timer duration). In general, higher priority levels may be assigned lower data volume thresholds (and potentially shorter timer durations) to meet specific latency specifications.

In still additional embodiments, a pseudo-asynchronous network operation (also referred to hereinafter as a super pooling process) can be utilized, where network devices may coordinate their data transmission. By way of a non-limiting example, certain network devices may be in a data accumulation phase (also referred to as a batch mode/first state), while another network device can be actively transmitting the accumulated data (i.e., in a burst mode/second state).

In some more embodiments, users may have the option to set configurations, such as, but not limited to, data volume thresholds, timer durations, and/or priority classifications, allowing the system to adapt to different networking needs. In certain embodiments, network devices can adjust their operational modes and configurations (e.g., data volume thresholds, timer durations) based on the time of day or other temporal patterns (e.g., a day of week, a month of year, a date range, a season, etc.). By way of a non-limiting example, configurations may be varied for busier times, such as daytime business hours, or for more inactive periods, such as nighttime or holiday season. In yet more embodiments, the various aspects may work collectively to create a dynamic, demand-responsive network device that may significantly contribute to reducing energy consumption.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom very large-scale integration (VLSI) circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

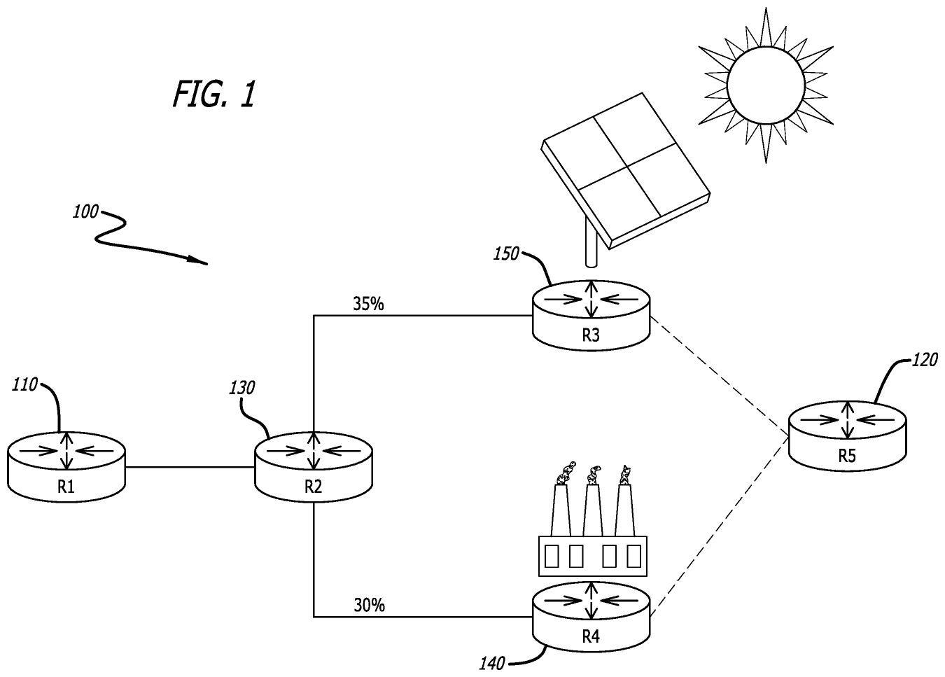

Referring to FIG. 1, a schematic diagram of a network 100 with network devices powered by various power source types in accordance with an embodiment of the disclosure is shown. The network 100 can include a plurality of devices, e.g., routers 110, 130, 140 and 150, which can be in communication with each other and/or a remote server, such as a cloud-based server 120. The network 100 depicted in FIG. 1 is shown as a simplified, conceptual network. Those skilled in the art will understand that a network 100 can include a large variety of devices and be arranged in a virtually limitless number of combinations based on the desired application and available deployment environment.

Additionally, it is recognized that the terms “power” and “energy” are often used interchangeably in many colloquial settings but have distinct differences. Specifically, energy is accepted as the capacity of a system or device to do work (such as in kilowatt-hours (kWh)), while power is the rate at which energy is transferred (often in watts (W)). Power represents how fast energy is being used or produced. With this in mind, it should be understood that various elements of the present disclosure may utilize common terms like “power lines,” “power grids,” power source,” “power consumption,” and “power plant” when describing energy delivery and utilization, even though those skilled in the art will recognize that those elements are delivering or processing energy (specifically electricity) at a certain rate of power. References to these terms are utilized herein specifically to increase the ease of reading.

Traditionally, devices operating within a network 100 have not considered various aspects of operation that can relate to the overall sustainability of the network. For example, devices in communication networks have often used grid-supplied energy as a primary power source. This grid-supplied energy can regularly provide energy that has been generated by a negative environmental impacts-heavy power source such as a coal-powered power plant. However, modern power grids often have more diverse and cleaner energy sources for the provided generated energy. Some devices can still be powered by power sources that utilize fossil fuels, such as the router R4 140 as depicted in FIG. 1. Alternatively, some devices can operate by using renewable sources of energy, such as the router R3 150 which is conceptually depicted as being powered by solar power.

Those skilled in the art will recognize that the generation of electricity within the various power plants often creates some pollution or, more generally, one or more negative environmental impacts, which can often come in the form of emissions. However, these negative environmental impacts can come in a variety of forms including, but not limited to, land use, ozone depletion, ozone formation inhibition, acidification, eutrophication (freshwater, marine, and terrestrial), abiotic resource depletion (minerals, metals, and fossil fuels), toxicity, water use, negative soil quality change, ionizing radiation, hazardous waste creation, etc. As such, these negative environmental impact measurements can be measured with specific units to quantify these changes. Various aspects of energy use can be associated with one or more of these negative environmental impacts and classified as one or more sustainability-related attributes.

In the embodiment depicted in FIG. 1, the operation of a coal-powered power plant will create a sizeable amount of negative environmental impacts in the form of carbon emissions and the like. Contrast that with a solar array which may not create emissions when generating electricity, but may negative environmental impacts, such as carbon emission generation, associated with the production and/or disposal of the solar array. Various methods of measuring these negative environmental impacts may occur. One measurement may be to examine the waste products created by the power generated (such as nuclear waste, vs. solar array e-waste, etc.).

Another measurement of negative environmental impacts that can be utilized when comparing power sources is to determine the amount of greenhouse or carbon emissions released per unit of electricity generated. Specifically, various embodiments described herein may utilize the CO₂e kg/kWh metric which measure the amount of kilowatt hours produced per kilogram of carbon dioxide gases released into the environment. Therefore, when discussing a negative environmental impacts-heavy power source compared to a clean(er) power source, the clean power source can, for example, have a better CO₂e kg/kWh rating compared to the negative environmental impacts-heavy power source. Utilizing a cleaner power source thus provides for a more sustainable network operation.

In order the maximize the overall sustainability of a network, it may be desirable to increase the use of cleaner power sources with a lower overall negative environmental impact as opposed to power sources with a higher overall negative environmental impact when operating the network. Thus, there can be a need to be aware of the source of energy provided at each device along the route of data travel. Additionally, other factors such as the attributes unique to each device can be factored in, along with the current and/or expected traffic, etc. Once known, an optimal method of traversing the data may need to be calculated. As discussed in more detail, this path algorithm can be utilized to better optimize the locations selected within a network for data travel.

Other methods may be utilized to increase sustainability in network operations. In many embodiments, the network devices themselves may have one or more features or other capabilities that can allow for a more efficient operation. For example, a network router may be operated in a lower power mode or be powered off entirely for a specific period of time or until an event occurs. Additional embodiments may utilize various other power-saving capabilities that can be turned on or off remotely or in response to an event or predetermined threshold being exceeded. Often, operations performed by the network devices can be utilized in scenarios where network performance will not be affected or is affected such that no loss in user experience occurs. By utilizing less power during operation, a higher level of sustainability can be achieved.

Together, the type of power source providing electricity to a network device, along with the various sustainability-related capabilities of the router can be understood as the sustainability-related attributes of that network device. During operation, one or more devices within the network may seek and collect the sustainability-related attributes of various network devices, which can provide insight into both the type of power source providing power to the device, but also the various capabilities of the network device that may be activated to provide more efficient operation.

Additionally, when generating various scores, metrics, or other evaluations of the network devices within a network 100, the sustainability-related attributes can vary based on a variety of factors such as the time of day, current network traffic, expected network traffic, and historical usage patterns. For example, a network router may receive energy from a solar power source during the day but receives energy from a coal-powered power plant at night. In these instances, an averaged score may be used, or a unique score may be generated at the time of operation. In another example, network traffic may be such that removing one or more network devices from the optimal sustainable data paths may negatively affect user experiences, such as when a sporting event occurs. As such, scores may be generated at numerous times depending on the desired application. Often, the act of measurement may negatively affect sustainability such that determining the proper amount of measurements for a given outcome may be determined.

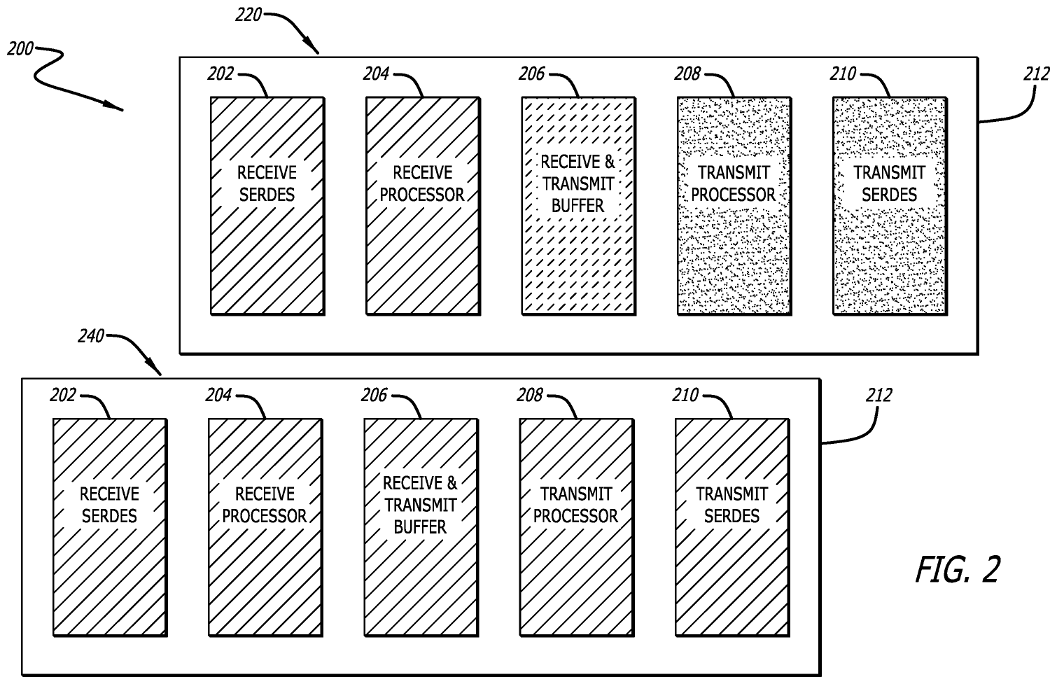

Although a specific embodiment for a network 100 is described above with respect to FIG. 1, any of a variety of systems and/or processes may be utilized in accordance with embodiments of the disclosure. For example, the network could be broken into a plurality of partitions, wherein each partition could have specific needs, service level agreements, etc. that can alter sustainability-optimization. The elements depicted in FIG. 1 may also be interchangeable with other elements of FIGS. 2-8 as required to realize a particularly desired embodiment. Augmented protocols to carry out these described processes are described below.

Referring to FIG. 2, a diagram 200 illustrating the energy consumption states of various components within a transceiver circuitry of a network device in accordance with various embodiments of the disclosure is shown. In the embodiments depicted in the diagram 220, a transceiver circuitry 212 may include various components that can consume power in a differentiated manner. In many embodiments, the RX components, which may include an RX serializer/deserializer (SerDes) 202 and an RX processor 204, can continuously operate and consume energy while the transceiver circuitry 212 is in operation for network data reception. In general, the RX SerDes 202 may convert data between serial data and parallel interfaces (in particular, from serial to parallel for RX), and the RX processor 204 can process received signals. Processing received signals may involve various tasks such as, but not limited to, filtering, amplification, demodulation, and error detection and correction. In a number of embodiments, the TX components, which can include a TX processor 208 and a TX SerDes 210, may be switched off by default and may consume no energy when no data is being transmitted. The TX components can enter an active state and consume energy upon the network device reaching a demand for data transmission, and may return to the default, off state once the data transmission is completed. In general, the TX SerDes 210 may convert data between serial data and parallel interfaces (in particular, from parallel to serial for TX), and the TX processor 208 can process data to be transmitted. Processing the data to be transmitted can involve various tasks such as, but not limited to, error detection and correction coding. In a variety of embodiments, a buffer 206 may be partitioned into sub-components, where the RX buffer can continuously operate and consumer energy, while the TX buffer may conserve energy by activating just when data is queued for transmission.

In the embodiments depicted in the diagram 240, the transceiver circuitry 212 can be in an operational state where all components, including the RX SerDes 202, the RX processor 204, the RX and TX parts of the buffer 206, the TX processor 208, and the TX SerDes 210, are active and consuming energy. In some embodiments, this condition may occur when the network device transitions into an active data transmission mode, engaging the TX components to process and forward the accumulated data. Accordingly, in more embodiments, a network device may engage in a batch operation, where the RX components of the transceiver may operate continuously to receive and accumulate data with the TX components of the transceiver being turned off by default. Upon reaching a threshold volume of data and/or when a timeout occurs, the network device can activate the TX components to initiate the forward transmission of the accumulated data. The embodiments depicted in the diagram 240 can show the power consumption condition of the transceiver when the accumulated data is being transmitted. After the data transmission is completed, the TX components can be turned off again to return to the energy-conserving state.

Although a specific embodiment for a transceiver circuitry suitable for carrying out the various steps, processes, methods, and operations described herein is discussed with respect to FIG. 2, any of a variety of systems and/or processes may be utilized in accordance with embodiments of the disclosure. For example, the network device may employ a power management system that adjusts energy consumption in response to changes in network traffic, environmental conditions, or power supply constraints. The elements depicted in FIG. 2 may also be interchangeable with other elements of FIGS. 1 and 3-8 as required to realize a particularly desired embodiment.

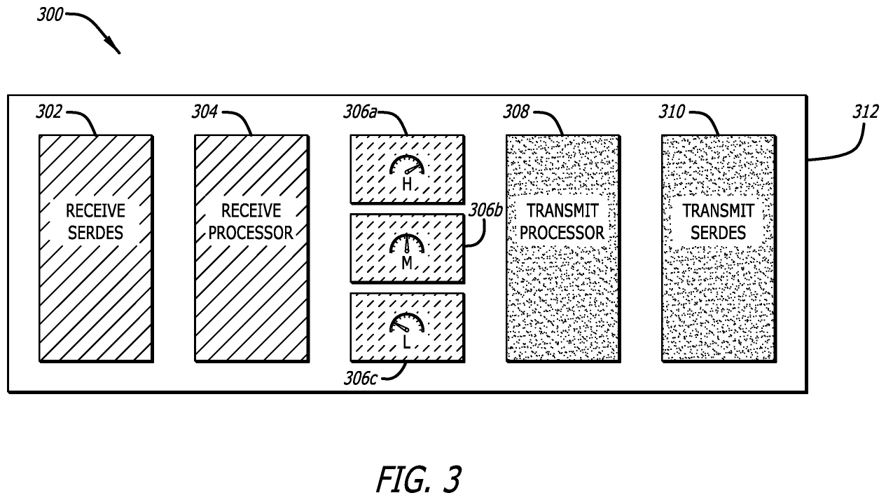

Referring to FIG. 3, a diagram 300 illustrating the transceiver circuitry of a network device configured to accommodate data associated with different priority classifications in accordance with various embodiments of the disclosure is shown. In the embodiments depicted in FIG. 3, in the transceiver circuitry 312, the RX and TX components may be similar to those described in FIG. 2. In many embodiments, the RX SerDes 302 and the RX processor 304 can continuously operate to receive data. In a number of embodiments, the TX processor 308 and the TX SerDes 310 may remain in an off state by default, and can be activated to process and forward data as demanded.

In a variety of embodiments, the buffer in the transceiver circuitry 312 may include multiple portions, each dedicated to handling data packets based on their assigned priority levels. In the embodiments depicted in FIG. 3, a first buffer portion 306a may be allocated for high-priority data. Examples of types of data that may be given the high-priority classification can include, but are not limited to, urgent messages, streaming videos, and/or audio/video calls. The high-priority data may have stringent latency requirements. In some embodiments, the high-priority data may specify instant transmission/forwarding without batching. In more embodiments, a second buffer portion 306b can be allocated for medium-priority data. Examples of types of data that may be given the medium-priority classification can include, but are not limited to, group emails and/or large group notifications. The medium-priority data can be associated with relatively less urgency in data transmission, and instant transmission may not typically be needed. In additional embodiments, a third buffer portion 306c may be allocated for low-priority data. Examples of types of data that may be given the low-priority classification can include, but are not limited to, emails scheduled to be delivered latter and/or non-urgent notifications. The low-priority data may generally be not urgent, and batching can typically be used for the low-priority data.

In further embodiments, the network device may utilize different threshold accumulated data volumes and/or timeout mechanisms for each priority classification within the buffer. In still more embodiments, the high-priority data in the first buffer portion 306a may be subject to a lower data threshold and/or a shorter timeout timer duration, ensuring low latency transmission. If instant transmission is specified for the high-priority data, a zero threshold data volume and/or a zero timeout timer duration can be utilized, which may mean that a high-priority data packet is forwarded toward the destination as soon as it is received at the network device and batching is disabled for the high-priority data. Conversely, the medium-priority data in the second buffer portion 306b and the low-priority data in the third buffer portion 306c can be associated with increasingly higher threshold data volumes and/or longer timeout timer durations, respectively, so that batching may be utilized and the TX components can be kept in the off state for longer periods between activations to reduce energy consumption.

Although a specific embodiment for a transceiver circuitry suitable for carrying out the various steps, processes, methods, and operations described herein is discussed with respect to FIG. 3, any of a variety of systems and/or processes may be utilized in accordance with embodiments of the disclosure. For example, the network device can further include a dynamic reallocation system that adjusts the capacity of different portions within the buffer, depending on current network demands, to maximize efficient use of resources. The elements depicted in FIG. 3 may also be interchangeable with other elements of FIGS. 1, 2, and 4-8 as required to realize a particularly desired embodiment.

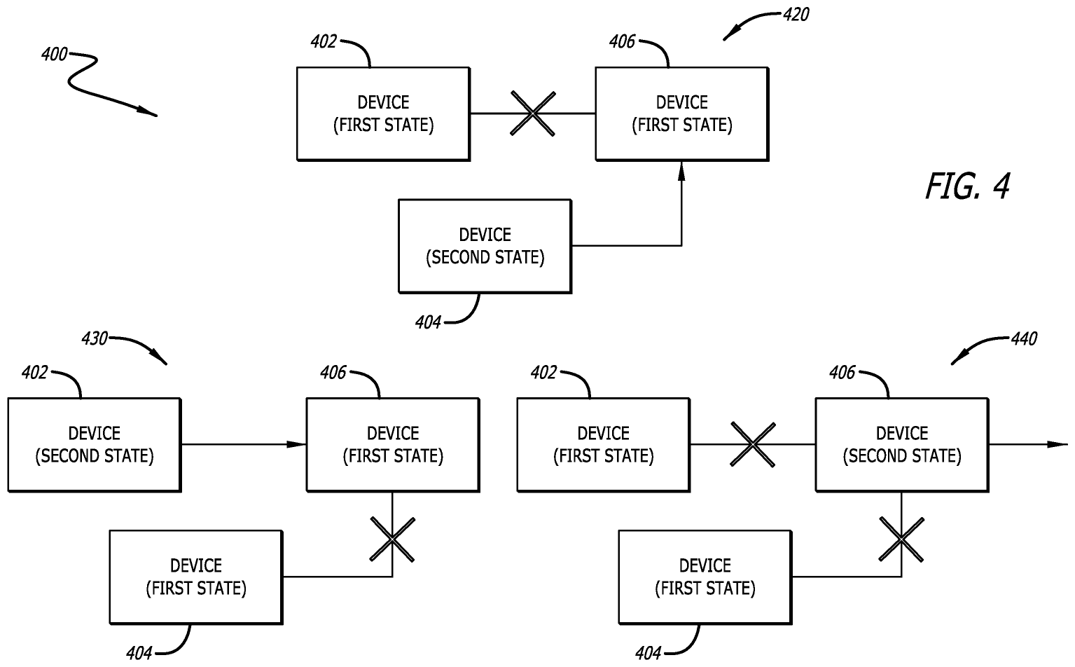

Referring to FIG. 4, a diagram 400 illustrating the super pooling process among network devices in accordance with various embodiments of the disclosure is shown. In the embodiments depicted in FIG. 4, in many embodiments, the diagram 420 may represent the initial step in the super pooling sequence, where the network device 402 can in a batch mode (also referred to hereinafter as the first state), accumulating data packets without transmitting them. The network device 406, also in the batch mode, may be similarly receiving and accumulating data, remaining in a standby state concerning data transmission. Accordingly, the TX components in the transceiver circuitries of the network device 402 and the network device 406 may be in the off state to reduce energy consumption. Concurrently, the network device 404 can be in a burst mode (also referred to hereinafter as the second state), actively transmitting its accumulated data towards the network device 406, which may temporarily store the incoming data from network device 404.

In a number of embodiments, the diagram 430 can depict an intermediate step of the super pooling process. Here, the network device 404 may transition into the batch mode, no longer actively transmitting but rather accumulating data for a subsequent transmission burst. The network device 402 can activate its burst mode, initiating the transmission of its accumulate data towards the network device 406. In the meantime, the network device 406 may continue to act as a temporary repository, accumulating received data from the network device 402 without transmitting data.

In a variety of embodiments, the diagram 440 may illustrate the subsequent step in super pooling. During this phase, both network devices 402 and 404 can be in the batch mode, efficiently collecting data while conserving energy by turning and keeping the TX components off. In contrast, the network device 406 may switch to the burst mode to transmit the data that has been accumulated from prior exchanges with the network devices 402 and 404. Accordingly, the network devices 402, 404, and 406 can be viewed, collectively, as a pseudo-asynchronous network.

Although a specific embodiment for the super pooling process suitable for carrying out the processes and operations described herein is discussed with respect to FIG. 4, any of a variety of systems and methods may be utilized in accordance with embodiments of the disclosure. For example, a scheduling algorithm may be implemented to manage the batch and burst modes among the network devices, ensuring that energy efficiency is maximized and data traffic is seamlessly managed. The elements depicted in FIG. 4 may also be interchangeable with other elements of FIGS. 1-3 and 5-8 as required to realize a particularly desired embodiment.

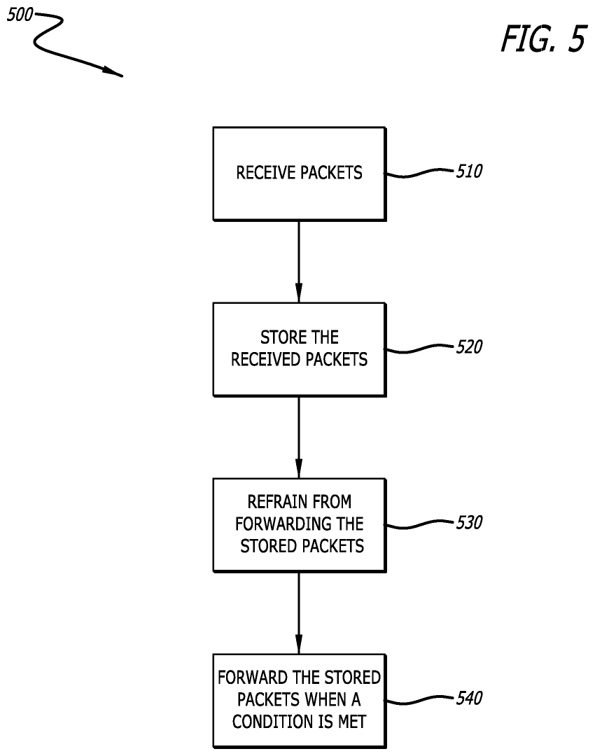

Referring to FIG. 5, a flowchart showing a process 500 for managing data packet storage and transmission in a network device in accordance with various embodiments of the disclosure is shown. In many embodiments, the process 500 may receive one or more packets (block 510). In a number of embodiments, these packets can be sourced from a variety of other network devices. In a variety of embodiments, a network interface controller of the network device may be configured to provide access to the network to facilitate the reception of the packets.

In some embodiments, process 500 can store the received packets (block 520). In more embodiments, the storage may act as a temporary buffer, allowing the network device to manage its power consumption and wait for an appropriate moment for packet transmission. In additional embodiments, during this phase, the RX buffer of the network device can be operational and the TX buffer of the network device may be switched off to reduce energy consumption.

In further embodiments, the process 500 can refrain from forwarding the stored packets (block 530). In still more embodiments, the network device may refrain from forwarding the stored packets if a condition for forwarding the packets is not met. By way of a non-limiting example, the network device may refrain from forwarding the stored packets if the stored packets include fewer than a threshold number of data packets. In still further embodiments, the TX components of the network device (which can include a TX processor and a TX SerDes) may remain off to reduce energy consumption.

In still additional embodiments, the process 500 may forward the stored packets when the condition is met (block 540). In some more embodiments, the network device can activate the TX components to forward the stored packets. In certain embodiments, once the forwarding of the stored packets is completed, the network device can switch off the TX components, reverting to a low-power state to conserve energy.

Although a specific embodiment for managing packet storage and transmission suitable for carrying out the processes and operations described herein is discussed with respect to FIG. 5, any of a variety of systems and processes may be utilized in accordance with embodiments of the disclosure. For example, a machine learning can be utilized to adapt the condition based on observed data patterns, contributing to further efficiency improvements. The elements depicted in FIG. 5 may also be interchangeable with other elements of FIGS. 1-4 and 6-8 as required to realize a particularly desired embodiment.

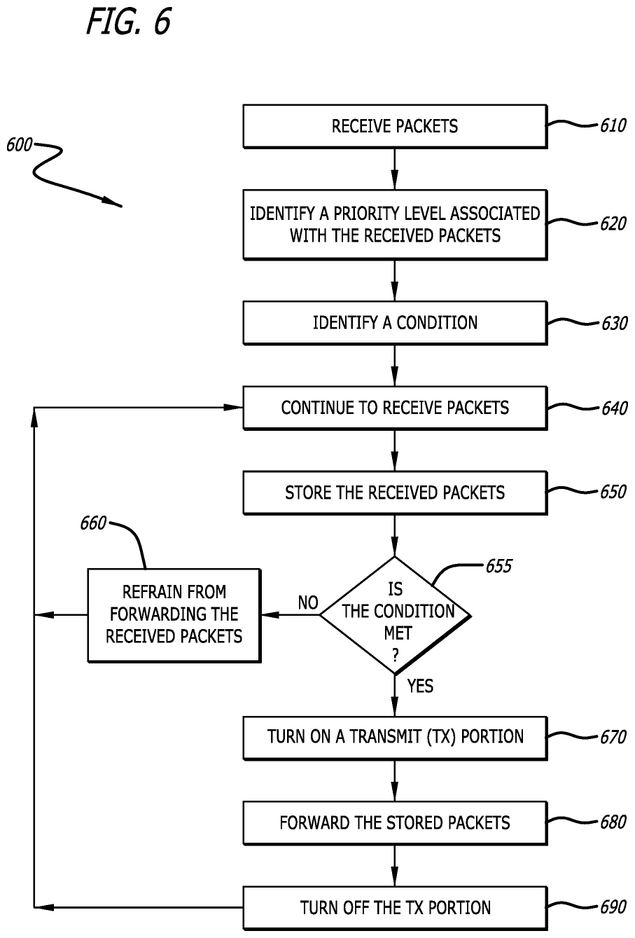

Referring to FIG. 6, a flowchart showing a process 600 for managing data packet storage and transmission in a network device in accordance with various embodiments of the disclosure is shown. In many embodiments, the process 600 may receive one or more packets (block 610). In a number of embodiments, the network device can receive the data packets from one or several other network devices. In a variety of embodiments, a network interface controller of the network device may be configured to provide network access.

In some embodiments, the process 600 can identify a priority level associated with the received packets (block 620). In more embodiments, the priority classifications may be derived from service level agreements. In additional embodiments, the priority classifications can be based on a quality of service (QOS) specification. By way of a non-limiting example, the received packets may each be associated with one of a high priority level, a medium priority level, or a low priority level.

In further embodiments, the process 600 may identify a condition (block 630). In still more embodiments, the condition can guide the timing of packet transmission from the network device. In still further embodiments, the condition may relate to the number of packets received and accumulated and/or a timeout timer expiration.

In still additional embodiments, the process 600 can continue to receive packets (block 640). In some more embodiments, the network device can continue to receive the data packets from one or several other network devices. In certain embodiments, the network interface controller of the network device may be configured to provide network access to facilitate the reception of the data packets.

In yet more embodiments, the process 600 may store the packets (block 650). In still yet more embodiments, the packets can be accumulated in the buffer as they await possible transmission based on the fulfillment of the condition. In many further embodiments, during this phase, the RX buffer of the network device can be operational, and the TX buffer of the network device may be switched off to reduce energy consumption.

In many additional embodiments, the process 600 may determine if the condition (for transmission) has been met (decision block 655). If the condition has not been met, the process 600 can refrain from forwarding the packets (block 660) and may continue the packet reception process. By way of a non-limiting example, the network device may refrain from forwarding the stored packets if the stored packets include fewer than a threshold number of data packets (and the timeout timer has not expired). In still yet further embodiments, the threshold number of data packets and/or the timeout timer duration may be inversely correlated with the respective priority level of the data packets. In still yet additional embodiments, the TX components of the network device (which can include a TX processor and a TX SerDes) may remain off to reduce energy consumption. On the other hand, if the condition has been met, in several embodiments, the process can activate the TX portion of the network device.

In several more embodiments, the process 600 can activate the TX portion of the network device (block 670). In numerous embodiments, the TX portion/components of the network device may include one or more of a TX processor, a TX SerDes, or a TX buffer. In numerous additional embodiments, the network device can activate the TX portion to prepare for the upcoming data transmission.

In further additional embodiments, the process 600 may forward the stored packets (block 680). In some embodiments, during the transmission phase, TX components such as, but not limited to, the TX processor, the TX SerDes, or the TX buffer can be utilized to send out the packets. In more embodiments, the network device may forward all the accumulated data packets (or all the accumulated data packets at the priority level) based on their destinations.

In additional embodiments, the process 600 can turn off the TX portion (block 690). In further embodiments, the TX portion/components to be turned off may include one or more of a TX processor, a TX SerDes, or a TX buffer. In still more embodiments, the network device can return to continue receiving packets subsequent to turning off the TX portion.

Although a specific embodiment for managing packet storage and transmission suitable for carrying out the processes and operations described herein is discussed with respect to FIG. 6, any of a variety of systems and processes may be utilized in accordance with embodiments of the disclosure. For example, an adaptive traffic management logic may optimize storage and forwarding timings based on real-time network activity analysis. The elements depicted in FIG. 6 may also be interchangeable with other elements of FIGS. 1-5, 7, and 8 as required to realize a particularly desired embodiment.

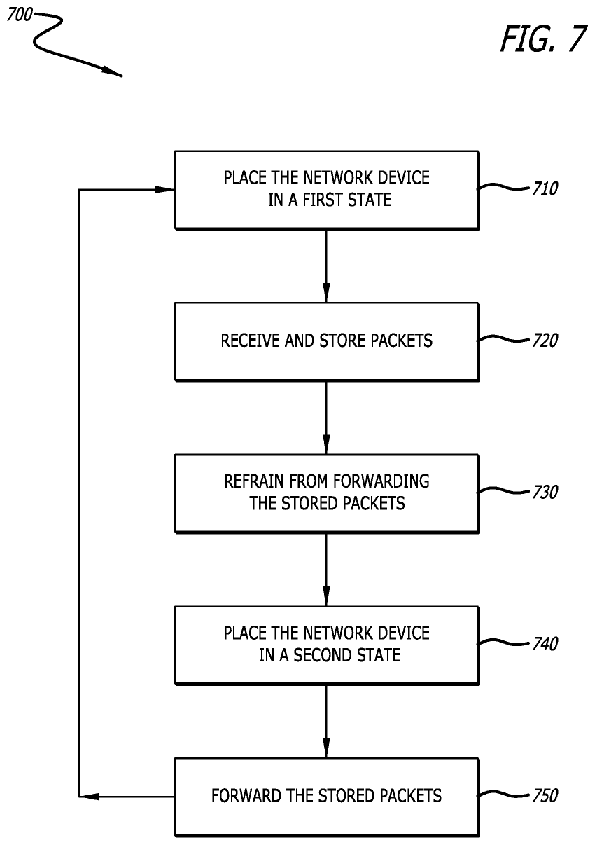

Referring to FIG. 7, a flowchart showing a process 700 for super pooling in a pseudo-asynchronous network in accordance with various embodiments of the disclosure is shown. In many embodiments, the process 700 may place the network device in a first state (block 710). The first state may also be referred to as the batch mode. In a number of embodiments, in this state, the TX portion of the network device can remain off, allowing the network device to conserve power. In a variety of embodiments, the network device can receive data packets from one or several other network devices that are in a second state (the burst mode).

In some embodiments, the process 700 can receive and store packets (block 720). In more embodiments, a network interface controller of the network device may be configured to provide access to enable the network device to receive the data packets. In additional embodiments, the network device can store the received packets in a buffer.

In further embodiments, the process 700 may refrain from forwarding the stored packets (block 730). In still more embodiments, refraining, for periods of time, from forwarding the packets can help to optimize energy usage by reducing the periods of time during which the TX portion of the network device is activated. In still further embodiments, the TX portion/components that may remain off can include one or more of a TX processor, a TX SerDes, or a TX buffer.

In still additional embodiments, the process 700 can place the network device into a second state (block 740). The second state may also be referred to as the burst mode. In some more embodiments, the shift to the second state can involve activating the TX portion, which may include one or more of the TX processor, TX SerDes, or the TX buffer. In certain embodiments, the network device can activate the TX portion to prepare for active data transmission.

In yet more embodiments, the process 700 can forward the stored packets (block 750). In still yet more embodiments, the network device may forward the stored packets to one or several other network devices that can be in the first state. In many further embodiments, after completing the packet forwarding, the network device can return to the first state and deactivate the TX portion, thereby reducing energy consumption.

Although a specific embodiment for super pooling in a pseudo-asynchronous network suitable for carrying out the processes and operations described herein is discussed concerning FIG. 7, any of a variety of systems and processes may be utilized in accordance with embodiments of the disclosure. For example, predictive analytics can be employed to determine optimal times for transitioning between the first and second states. The elements depicted in FIG. 7 may also be interchangeable with other elements of FIGS. 1-6 and 8 as required to realize a particularly desired embodiment.

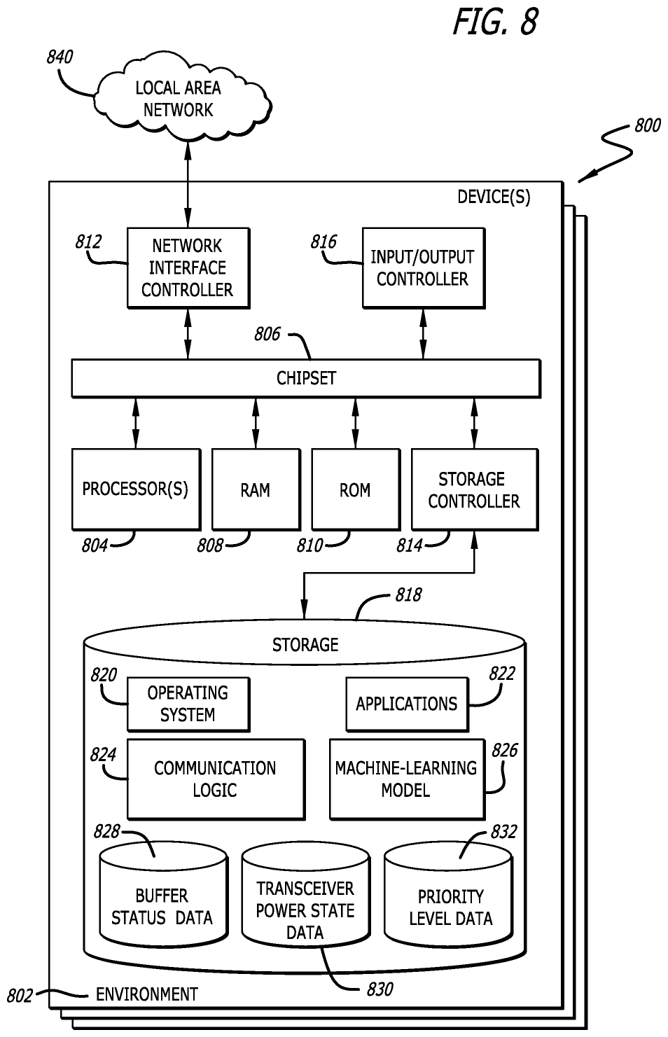

Referring to FIG. 8, a conceptual block diagram for one or more devices 800 capable of executing components and logic for implementing the functionality and embodiments described above is shown. The embodiment of the conceptual block diagram depicted in FIG. 8 can illustrate a conventional server computer, workstation, desktop computer, laptop, tablet, network appliance, e-reader, smartphone, or other computing device, and can be utilized to execute any of the application and/or logic components presented herein. The device 800 may, in some examples, correspond to physical devices or to virtual resources described herein.

In many embodiments, the device 800 may include an environment 802 such as a baseboard or “motherboard,” in physical embodiments that can be configured as a printed circuit board with a multitude of components or devices connected by way of a system bus or other electrical communication paths. Conceptually, in virtualized embodiments, the environment 802 may be a virtual environment that encompasses and executes the remaining components and resources of the device 800. In more embodiments, one or more processors 804, such as, but not limited to, central processing units (“CPUs”) can be configured to operate in conjunction with a chipset 806. The processor(s) 804 can be standard programmable CPUs that perform arithmetic and logical operations necessary for the operation of the device 800.

In additional embodiments, the processor(s) 804 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In certain embodiments, the chipset 806 may provide an interface between the processor(s) 804 and the remainder of the components and devices within the environment 802. The chipset 806 can provide an interface to a random-access memory (“RAM”) 808, which can be used as the main memory in the device 800 in some embodiments. The chipset 806 can further be configured to provide an interface to a computer-readable storage medium such as a read-only memory (“ROM”) 810 or non-volatile RAM (“NVRAM”) for storing basic routines that can help with various tasks such as, but not limited to, starting up the device 800 and/or transferring information between the various components and devices. The ROM 810 or NVRAM can also store other application components necessary for the operation of the device 800 in accordance with various embodiments described herein.

Different embodiments of the device 800 can be configured to operate in a networked environment using logical connections to remote computing devices and computer systems through a network, such as the network 840. The chipset 806 can include functionality for providing network connectivity through a network interface card (“NIC”) 812, which may comprise a gigabit Ethernet adapter or similar component. The NIC 812 can be capable of connecting the device 800 to other devices over the network 840. It is contemplated that multiple NICs 812 may be present in the device 800, connecting the device to other types of networks and remote systems.

In further embodiments, the device 800 can be connected to a storage 818 that provides non-volatile storage for data accessible by the device 800. The storage 818 can, for example, store an operating system 820, applications 822, buffer status data 828, transceiver power state data 830, and priority level data 832, which are described in greater detail below. The storage 818 can be connected to the environment 802 through a storage controller 814 connected to the chipset 806. In certain embodiments, the storage 818 can consist of one or more physical storage units. The storage controller 814 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 800 can store data within the storage 818 by transforming the physical state of the physical storage units to reflect the information being stored. The specific transformation of physical state can depend on various factors. Examples of such factors can include, but are not limited to, the technology used to implement the physical storage units, whether the storage 818 is characterized as primary or secondary storage, and the like.

For example, the device 800 can store information within the storage 818 by issuing instructions through the storage controller 814 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 800 can further read or access information from the storage 818 by detecting the physical states or characteristics of one or more particular locations within the physical storage units.

In addition to the storage 818 described above, the device 800 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 800. In some examples, the operations performed by a cloud computing network, and or any components included therein, may be supported by one or more devices similar to device 800. Stated otherwise, some or all of the operations performed by the cloud computing network, and or any components included therein, may be performed by one or more devices 800 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 818 can store an operating system 820 utilized to control the operation of the device 800. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 818 can store other system or application programs and data utilized by the device 800.

In various embodiment, the storage 818 or other computer-readable storage media is encoded with computer-executable instructions which, when loaded into the device 800, may transform it from a general-purpose computing system into a special-purpose computer capable of implementing the embodiments described herein. These computer-executable instructions may be stored as application 822 and transform the device 800 by specifying how the processor(s) 804 can transition between states, as described above. In some embodiments, the device 800 has access to computer-readable storage media storing computer-executable instructions which, when executed by the device 800, perform the various processes described above with regard to FIGS. 1-7. In more embodiments, the device 800 can also include computer-readable storage media having instructions stored thereupon for performing any of the other computer-implemented operations described herein.

In still further embodiments, the device 800 can also include one or more input/output controllers 816 for receiving and processing input from a number of input devices, such as a keyboard, a mouse, a touchpad, a touch screen, an electronic stylus, or other type of input device. Similarly, an input/output controller 816 can be configured to provide output to a display, such as a computer monitor, a flat panel display, a digital projector, a printer, or other type of output device. Those skilled in the art will recognize that the device 800 might not include all of the components shown in FIG. 8, and can include other components that are not explicitly shown in FIG. 8, or might utilize an architecture completely different than that shown in FIG. 8.

As described above, the device 800 may support a virtualization layer, such as one or more virtual resources executing on the device 800. In some examples, the virtualization layer may be supported by a hypervisor that provides one or more virtual machines running on the device 800 to perform functions described herein. The virtualization layer may generally support a virtual resource that performs at least a portion of the techniques described herein.

In many embodiments, the device 800 can include a communication logic 824. The communication logic 824 within the network device may manage the batching and transmission of data packets. The communication logic 824 can intelligently control the timing and prioritization of packet forwarding, ensuring that the TX portion of the network device is activated when necessary, in alignment with established thresholds and priority levels, to optimize for energy efficiency.

In a number of embodiments, the storage 818 can include buffer status data 828. The buffer status data 828 may reflect the current volume and classification of data packets stored in the buffering components of the network device. The buffer status data 828 can enable the communication logic 824 to dynamically assess whether the criteria for initiating a data burst transmission has been met and determine the optimal moment for activating the TX portion of the device.

In various embodiments, the storage 818 can include transceiver power state data 830. The transceiver power state data 830 may relate to the current energy consumption status of the transceiver components in the network device. The transceiver power state data 830 can allow for effective management of the power states, enabling the switching of the TX components from an off (inactive), energy-saving mode to an active state in response to the data traffic conditions, thereby enhancing overall energy efficiency.

In still more embodiments, the storage 818 can include priority level data 832. The priority level data 832 may be utilized to categorize incoming data packets based on the urgency of their transmission needs. The priority level data 832 can facilitate the differentiation and appropriate handling of packets to ensure that high-priority traffic is transmitted swiftly, respecting QoS specifications, while optimizing energy utilization at the network device.

Finally, in many embodiments, data may be processed into a format usable by a machine-learning model 826 (e.g., feature vectors), and or other pre-processing techniques. The machine-learning (“ML”) model 826 may be any type of ML model, such as supervised models, reinforcement models, and/or unsupervised models. The ML model 826 may include one or more of linear regression models, logistic regression models, decision trees, Naïve Bayes models, neural networks, k-means cluster models, random forest models, and/or other types of ML models 826. The ML model 826 may be configured to analyze past network traffic patterns and adjust the conditions for packet batching and transmission, such as altering threshold values and timeout timer durations, to enhance the energy efficiency and throughput of the network device over time.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A network device, comprising:
a processor;
at least one network interface controller configured to provide access to a network; and
a memory communicatively coupled to the processor, wherein the memory comprises a communication logic that is configured to:
receive one or more packets;
store, temporarily, the received one or more packets;
identify whether a condition is met; and
refrain from forwarding the stored one or more packets in response to the condition not being met, wherein a transmit (TX) portion of the network device is off when no packet is being forwarded from the network device.

2. The network device of claim 1, wherein the one or more packets are received from one or more other network devices.

3. The network device of claim 1, wherein the communication logic is further configured to forward at least some of the stored one or more packets to at least a first network device in response to the condition being met, wherein the TX portion of the network device is on when the at least some of the stored one or more packets are being forwarded.

4. The network device of claim 3, wherein the communication logic is further configured to turn off the TX portion of the network device in response to the forwarding of the at least some of the stored one or more packets being completed.

5. The network device of claim 1, wherein the TX portion of the network device includes one or more of a TX processor, a TX serializer/deserializer (SerDes), or a TX buffer.

6. The network device of claim 1, wherein the condition is met when the stored one or more packets include at least a number of packets associated with a threshold number.

7. The network device of claim 6, wherein the one or more packets are each associated with a priority level.

8. The network device of claim 7, wherein the priority level is selected from a group consisting of a predetermined number of possible priority levels.

9. The network device of claim 7, wherein the priority level corresponds to a quality of service (QOS) specification.

10. The network device of claim 7, wherein the threshold number is based at least in part on the priority level.

11. The network device of claim 10, wherein the threshold number and the priority level are inversely correlated.

12. The network device of claim 7, wherein the threshold number is based at least in part on at least one of a time of day, a day of week, a month of year, a date range, or a season.

13. The network device of claim 1, wherein the condition is met when a timer expires, and wherein the timer is reset when forwarding of at least some of the stored one or more packets is completed.

14. The network device of claim 13, wherein the one or more packets are each associated with a priority level.

15. The network device of claim 14, wherein a duration of the timer is based at least in part on the priority level.

16. The network device of claim 15, wherein the duration of the timer and the priority level are inversely correlated.

17. The network device of claim 14, wherein a duration of the timer is based at least in part on at least one of a time of day, a day of week, a month of year, a date range, or a season.

18. The network device of claim 1, wherein the network device comprises a switch or a router.

19. A network device, comprising:
a processor;
at least one network interface controller configured to provide access to a network; and
a memory communicatively coupled to the processor, wherein the memory comprises a communication logic that is configured to:
place the network device in a first state, wherein a transmit (TX) portion of the network device is off when the network device is in the first state;
receive and store, temporarily, one or more packets from at least a first network device while the network device is in the first state, the first network device being in a second state;
place the network device in the second state, wherein the TX portion of the network device is on when the network device is in the second state; and
forward at least some of the stored one or more packets while the network device is in the second state, wherein the network device switches between the first state and the second state.

20. A method for forwarding packages implemented at a network device, comprising:
receiving one or more packets;
storing, temporarily, the received one or more packets;
identifying whether a condition is met; and
refraining from forwarding the stored one or more packets in response to the condition not being met, wherein a transmit (TX) portion of the network device is off when no packet is being forwarded from the network device.
